(19) United States
(12) Patent Application Publication
(10) Pub. No.: US 2005/0112244 A1
(43) Pub. Date: May 26, 2005

(54) Container having separate cells for protection and display of produce

(76) Inventor: Alex F. Hall, Los Angeles, CA (US)

Correspondence Address: MICHAEL BLAINE BROOKS, A PROFESSIONAL CORPORATION, 5010 NO. PARKWAY CALABASAS, SUITE 104, CALABASAS, CA, 91302-3913, US

(21) Appl. No.: 10/724,429

(22) Filed: Nov. 26, 2003

(51) Int. Cl. A23B 4/00

(52) U.S. Cl. 426/112

(57) ABSTRACT

In at least one embodiment the invention is a produce container with opened and closed positions, and includes a first tray, a second tray, a plurality of cells for containing produce items, and one or more spacers. With the produce container in its closed position, the first tray is positioned opposite the second tray. The cells are positioned within both the first and second trays. Each cell is separated from the others, preventing the produce items from contacting one another. The spacers are positioned between the first tray and the second tray, such that they define an air space therebetween. The produce container can also include a hinge mounted between the first tray and the second tray, such that the produce container can be translated from its open position to its closed position.

### BACKGROUND

Historically, produce including fruit and vegetables have been harvested, shipped and sold in bulk without employing any packaging other than, at times, a simple cardboard box or crate. Within such containers the produce is simply piled or stacked upon and against one another in mass without any separation or support therebetween. As a result, during shipping the produce is subject to damage from contact with one another, contact with the container, and from the weight of other produce positioned above. Such damage typically includes bruising, deformation, size reduction, skin splitting, breakage, crushing and the like.

With the produce being in contact with each other, any problem, which exists with some of produce, such as rot, mold and pests, can more easily pass from one item to another. This cross-contamination can relatively quickly destroy an entire container of produce. An addition problem is that the close positioning resulting from bulk packaging can cause certain fruit not to ripen properly. Since fruit must have a certain amount of fresh air about it to facilitate proper ripening, limiting the amount of air can cause the ripening to be retarded and/or uneven. Clearly, spoiled, moldy, infested, unripened, or unevenly ripened produce is less desired by the consumer.

Damage to produce can also occur during the handling associated with produce being put on display and/or when inspected by consumers prior to purchase. Further, bulk packaged produce can require a significant amount of labor at the point of sale to arrange in an ordered and aesthetically pleasing manner.

While this bulk packaging approach does tend to reduce the overall initial cost of packing and shipping the produce, it nevertheless results in a certain amount cost due to loss and damage. While this is generally accepted as a cost of doing business, it still has resulted in increased costs to the customer, reduced product quality and diminished profitability for the distributors and retailers.

As a result, in recent years distributors and wholesales have begun to employ a variety of different types of packaging to protect their produce from damage and loss. Of particular importance has been the protection of high value produce such as mangos, pears, and avocados. Materials, such as plastics, foam and cardboard, are formed into different shapes to package the produce. While many of these packages have helped reduce the amount of damage to a certain degree, they still possess a number of problems including produce damage and loss, lack of allowance for proper ripening and less then optimal product presentation.

Therefore, a need exists for produce packaging that protects and retains the fruit, facilitates uniform ripening, prevents spoilage, limits any cross-contamination, and provides an aesthetically pleasing presentation.

### SUMMARY

In at least one embodiment, the present invention is a produce container that has a first cell for containing a first produce item and a second cell for containing a second produce item. The first and second cells are separated from each other with a separation means defined between them. The separation means is capable of preventing the first produce item from contacting the second produce item.

The separation means can be a separation structure positioned between and connecting the first and second cells. The separation structure can be a semi-rigid or deformable structure. The separation structure can include one or more stops, which are positioned to be capable of restricting the movement of one or both of the produce items.

The first and second cells can be shaped to generally conform to the first and second produce items, respectfully. The first and second cells can be canted, such that the first and second produce items are positioned in a substantially reclined manner. Further, the first and second cells can be sized larger than their produce items, such that a gap is defined between the cell and the produce item. This gap can facilitate the circulation of fresh air about the produce items to aid in proper and more uniform ripening of fruit and/or to reduce the potential for problems such as mold. The cells can be any of a variety of shapes, including curved, teardrop, or generally conforming to the shape of the produce item.

In other embodiments, the invention is a produce container having a base structure and a cell positioned upon, or within, the base structure. The cell is for containing a produce item, and may be shaped to generally, nearly or substantially conform to the shape of the produce item. Also, a principal axis of the cell is canted relative to the plane of the base structure, such that the produce item is positioned at an angled attitude. The cell includes a cell axis that can be a longitudinal axis bisecting the cell. In turn, the base can be positioned about a plane that includes a base plane. To achieve the cant of the cell, the cell axis is set at a cant angle relative to the base plane. While the cant angle can be any of a variety of angles, in some embodiments the cant angle is within the ranges of between 0 and 90 degrees and between about 35 and about 40 degrees. In certain embodiments, the cant angle is substantially 37 degrees. Also, the cells may be of a variety of shapes including curved, teardrop and generally in the shape of a mango other produce.

In another embodiment the invention is a produce container that has an opened position and a closed position. The produce container includes a first tray, a second tray, a plurality of cells for containing produce items, and one or more spacers. With the produce container in its closed position, the first tray is positioned opposite the second tray. The cells are positioned within both the first tray and the second tray. Also, the cells are isolated from each other, in that each cell is separated from the others. This prevents the produce items from contacting one another and causing damage such as bruising, deformation, shrinkage, cross-contamination, and the like. The spacers are positioned between the first tray and the second tray such that they define an air space therebetween.

In some embodiments, the produce container includes a hinge. The hinge is mounted between the first tray and the second tray, such that the produce container can be translated from its open position to its closed position by rotationally elevating the first tray relative to the second tray about the hinge.

While the spacers are positionable about the trays, by placing one or more in or near the center of the trays greater structural support can be achieved. This support help to transfer vertical loads and aid in maintaining the air space defined between the trays. The center spacers are one or more in number and are positionable, such that they are surrounded by a group of cells. In some embodiments the cell groups are even number sets (e.g. four, six, eight, etc.) such that they surround the center spaces in groups of four. The center spacers can also include a lock for attaching the first tray and the second tray together when the produce container is in its closed position.

### BRIEF DESCRIPTION OF THE DRAWINGS

The above, as well as other advantages and features of the present invention are described below in greater detail according to the embodiments of the present invention in which:

FIGS. 1a and b show isometric views of a package in accordance with an embodiment of the present invention;

FIG. 1b show an isometric view of an open package in accordance with an embodiment of the present invention;

FIG. 2 shows a side cross-section view of a portion of a package in accordance with an embodiment of the present invention;

FIG. 3 shows a side cross-section view of a portion of a package in accordance with an embodiment of the present invention; and

FIG. 4 shows a side cross-section view of a portion of a package in accordance with an embodiment of the present invention.

### DETAILED DESCRIPTION

In some embodiments, the present invention is a produce container having one or more cells for containing produce. The cell or cells are arranged to isolate or separate the produce item they contain from other surrounding or adjacent produce. In so doing the contained produce item is protected from external damage due to causes such as impact, cross-contamination and the like. The cell(s) can be sized to define an air space between the contained produce item and the cell, to facilitate in the ripening of fruit and/or the prevention of damage due to problems such as mold. Further, the cell(s) can be positioned such that they place the contained produce at an angle to aid in the presentation at the point of sale and for inspection.

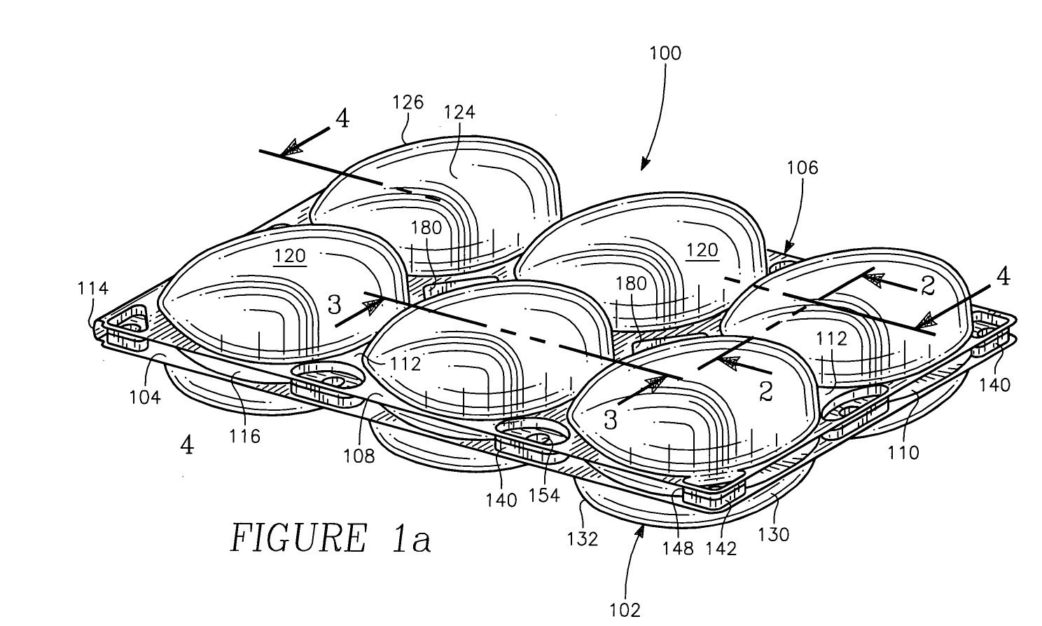

As shown in FIGS. 1a and b, a package or container 100 includes a lower, bottom, first or base tray 102, an upper, top, second or cover tray 106, a hinge 114, cells 120, edge spacers 140, a hinge spacer 160 and center spacers 180. As can be seen in FIG. 1b, the package 100 is capable of being opened by moving the upper tray 106 about the hinge 114, away from the lower tray 102. The edge spacers 140 may include locks 154, which along with the hinge 114 operate to secure the upper tray 106 and lower tray 102 together while the package is in it closed position. Opening the package can be achieved by first detaching each of the locks 154 to free the trays from each other. Opening the package 100 allows access to the produce capable of being stored within the package 100.

The package 100 is formed into a set of cells 120 which are shaped and sized to receive the particular produce that is being contained in the package 100. A portion of each cell is positioned on each tray within a lower interconnecting portion 104 of the lower tray 102 and a within an upper interconnecting portion 108 of the upper tray 106. The interconnecting portions 104 and 108 are generally planar, connecting the hinge 114, the cells 120, and the spacers 140, 160 and 180. Together the interconnecting portions 104 and 108 can form a base portion in which the cells 120 are positioned (the base portion being generally planar can have a base axis within this plane). The embodiment shown here has six tear-shaped cells set in two rows of three each on both the upper tray 106 and the lower tray 102. However, the specific number, shape and arrangement of the cells can vary depending on the particular embodiment.

As shown in FIGS. 1a and b, the edge spacers 140, hinge spacers 160 and center spacers 180 are positioned about the upper tray 106 and lower tray 102 and function to position the upper tray 106 and the lower tray 102 relative to one another. In the embodiment shown, the spacers 140, 160 and 180 are shaped to extend out away from the interconnecting portions 104 and 108 of the trays 102 and 106 respectfully, such that with the package 100 in its closed position, an air space 116 is defined between the interconnecting portions 104 and 108. The air space 116 allows the circulation of air about the produce to facilitate processes such as the ripening of fruit.

The package 100 can be formed in any of a variety of manners and of any of a variety of materials. For example, in at least one embodiment, the package is formed from a single piece of plastic, e.g., plastic sheet, using a shaped mold to define the hinge 114, cells 120, edge spacers 140, hinge spacers 160 and center spacers 180. To aid in the display and presentation of the produce at the point of sale and to otherwise allow for inspection, a clear plastic can be used to form the package 100. Depending on the particular embodiment, the package 100 can also be formed of an at least partially deformable material, so as to allow a degree of shock absorption to protect the produce from external impact damage. However, the material of the package 100 should be sufficiently ridged to restrict or limit the amount of deformation to substantially maintain the structure of the package, to resist damage and retain the produce therein. Besides plastic, alternate materials can include multicellular expanded synthetic resins (such as STYROFOAM®), cardboard, foamboard, paper, and the like. For materials not transparent, the hinge may be frangible or perforated or otherwise provide a means for severing the upper tray 106 from the lower tray 102.

In this embodiment of the present invention, the lower tray 102 and the upper tray 106 each contain opposing portions of the cells 120, edge spacers 140, hinge spacers 160, and center spacers 180 positioned about the lower interconnecting portion 104 and the upper interconnecting portion 108, respectfully. The positioning and separation of the cells 120, edge spacers 140, hinge spacers 160, and center spacers 180 provide for several advantages including the separation and retention of the produce.

The spacers 140, 160 and 180 are separated by various spacer separation regions 110 of the interconnecting portions 104 and 108. The particular size of the spacer separation regions 110 can vary, but they are sized to be less than the particular adjacent dimension of the nearby item of produce. That is, the space between two spacers positioned near one of the produce items is less than the associated size of the item, so as to restrain the produce from being substantially displaced from its initial position and/or being displaced out of the package 100. As such, the spacer separation regions 110 are sized to prevent the items of produce from coming into contact with each other and from exiting the package 100.

Similarly, the cells 120 are positioned within the upper tray 106 and the lower tray 102 to keep the produce separated from each other. A means of separation, e.g., separation means, is positioned between each of the cells and is capable of preventing the produce items from contacting each other. The means of separation can be a particular separation structure. As shown, the cells 120 are separated by cell separation regions 112, in both the upper interconnecting portion 104 and the lower interconnecting portion 108. The cell separation regions 112 function to prevent or at least limit damage due to produce items contacting one another. While particular size and shape of the cell separation regions can vary, depending on the specific embodiment, they should be sufficient to prevent or appropriately limit the occurrence of contact between produce. Factors which can determine the specific size and shape of the cell separation regions 112 for a particular embodiment, can include the size and shape of cells, the size and shape of the produce to be held in the cells, the flexibility of package material, size of the air space, and the like.

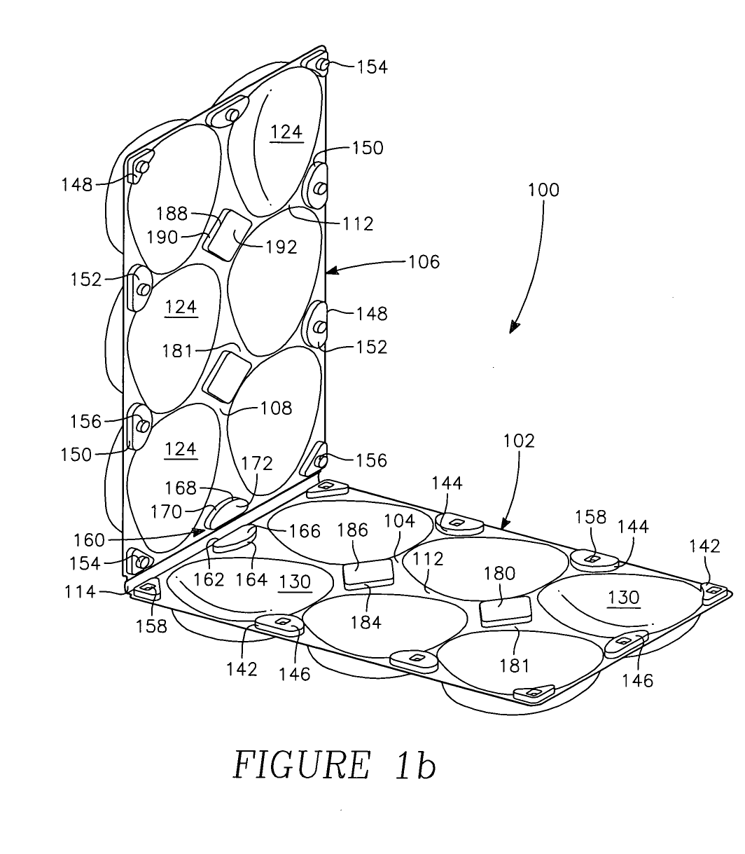

FIG. 2 shows a cross-section of the a portion of a package or container 200 showing a cell separation region 212 positioned between two adjacent cells 220. Each of the cells 220 is shown containing an item of produce, having curved sides that are capable of being positioned to extend pass the confines of the cells. The package 200 includes a lower tray 202, an upper tray 206 and an air space 216 defined therebetween. As shown, the width W of the cell separation region 212 is sufficient to prevent the curved sides of each produce item from coming to contact with the other. While the size of the width W can vary depending on the requirements of the specific embodiment, in some embodiments the width W is about 0.25 inches between adjacent cell sides and about 0.125 inches between the adjacent cell ends.

Returning to FIGS. 1a and b, the hinge 114 connects the lower tray 102 and the upper tray 106 allowing the package 100 to be opened. While the hinge can be formed in a number of different sizes and shapes, in the embodiment shown, the hinge 114 is a continuous strip running between and connecting an edge of the lower tray 102 and an opposing edge of the upper tray 106. The width of the hinge 114 is sufficient to aid in defining the air space 116. In alternate embodiments of the present invention, the package is provided without a hinge connecting the lower and upper trays. In such embodiments, the trays can be separated by just the spacers and secured together by a means other than the hinge, including locks set in the spacers, plastic wrap, tape and the like.

The cells 120 provide a variety of functions including: protecting the produce from damage and loss, such as that resulting from impact, departure and cross-contamination; facilitating ripening and mold reduction; and presentation of the produce. Each of these functions provides advantages of the present invention.

In addition to the placement of the cells 120, as noted above, produce protection can also be achieved through the sizing, shaping and the material of the cells 120. As noted, the cells 120 can be sized and shaped according to the type of produce that they will receive and retain. For instance, the cells 120 of the embodiment of the invention shown in FIGS. 1a and b have a curved teardrop shape for the packaging of similarly shaped produce items such as a mangos, pears, Asian pears, avocados and the like. In the particular embodiment shown, the cells 120 are formed to receive mangos. In other embodiments the cells can be shaped to match any of a variety of items, examples include, an elongated curved shape for yellow mangos or bananas, or a generally spherical shape for oranges, grapefruit and the like.

By forming the cells 120 in a manner that follows to the shape of the specific type of produce, the likelihood of damage to that produce will be reduced as the item will have less room to move within the cell 120. Therefore, even if the item does move to contact the cell, it will do so at a minimum speed and against a surface that is generally matched to that of the shape of the produce. Also, any potential damage can be further reduced by the cell 120 being of a deformable material, e.g., a formed plastic sheet, which may be capable of absorbing some of the impact.

Depending on the embodiment, the size and shape of the cells 120 is formable to closely, nearly, substantially or generally conform to the exterior shape of an average produce item of a particular type or grade. For example, for mangos the cells 120 can be formed to receive and retain 8.8/lbs to 11/lbs mangos.

Another function of the cells 120 is to facilitate ripening, when used to contain unripened fruit, and reducing the potential for problems such as mold. As noted above, one method of achieving this is with the air space 116, which allows fresh air to flow about the produce. An additional approach employed in certain embodiments of the invention, is to form the cells 120 slightly or moderately larger than the produce they will contain.

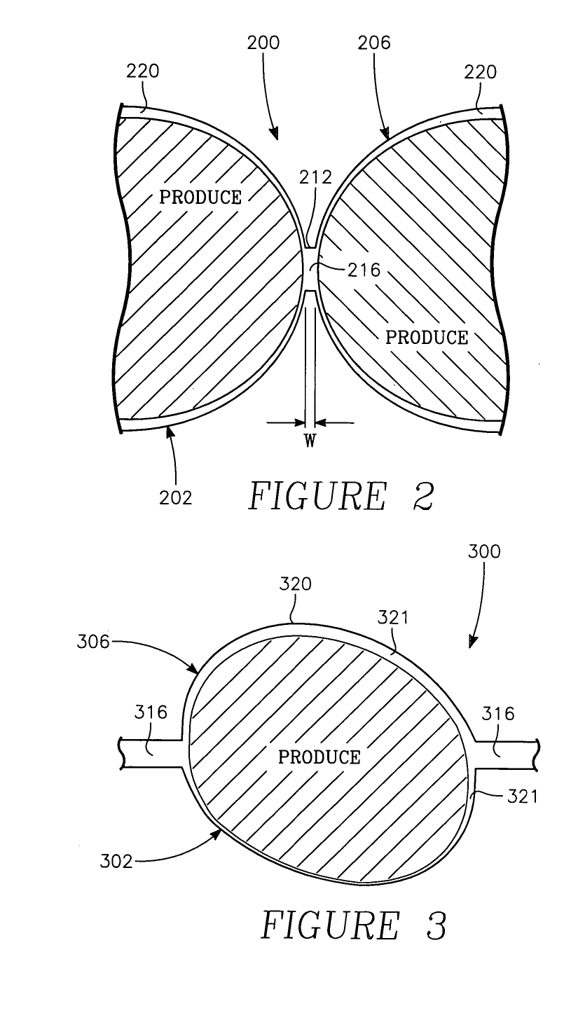

Shown in FIG. 3 is a portion of a package 300 with a cross-section of a cell 320 that is sized and shaped to generally conform with the size and shape of the produce item, but is slightly larger than the produce item. With the cell 320 formed larger than the produce, a cell air space 321 is defined between the cell 320 and the produce. As can be seen, except for one contact point, or more contact points, depending on the position of the item, the cell air space or gap 321 is generally positioned about the entire produce item. With the cell air space in communication with an air space 316 defined between a lower tray 302 and an upper tray 306 of the package 300, air can freely flow from the exterior of the package and about the produce item. This flow of fresh air to and about the produce item will facilitate both the uniform ripening of fruit and reduce the potential for problems such as mold.

As shown in FIGS. 1a and b, the cells 120 each include an upper section 124 and a lower section 130 which are respectfully sized and shaped to receive the upper and lower portions of the produce item. The upper portion 124 includes a curved surface 126 and the lower portion 130 includes a curved surface 132. Depending on the embodiment, the amount of the produce item that is received by either the upper section 124 and the lower section 130 can vary. For example, the lower section 130 can be sized to receive a relatively vast majority of the produce item, e.g. two-thirds or three-quarters, while the upper section 124 receives a relatively small minority of the item (e.g. one-third, one quarter, etc.). In another embodiment, the majority of the produce item is received by the upper section 124 and the minority by the lower section 130. In some embodiments, the produce item is received by only either the lower section 130, or the upper section 124, and not both as set forth in the embodiments detailed above. In such circumstances, the non-receiving section simply acts as a stop or arrester to prevent the item from displacing from the receiving section. As such, the stop section can be a flat structure or an extension of the surrounding interconnecting panel.

With the lower section 130 sized and shaped to receive at least a portion of the produce item, the loading and retention of the produce when the package is in its open position (e.g. FIG. 1b) is assisted.

A desired produce presentation is achievable by the shape of the cells 120. Namely, by forming the cells 120 into certain shapes, the produce can be positioned into any of a variety of orientations. Orientating the produce can be beneficial in that the produce can be positioned to be in a more aesthetically pleasing manner, to highlight certain portions of the produce over other areas, or to aid in the inspection of the produce. For example, with a package of mangos, the aesthetics are improved by placing the mangos such that they are view by the customer, with the wider portion of the fruit at the bottom, the narrower portion position above the wider portion (e.g. at the top), and with the fruit positioned in an angled or reclining manner.

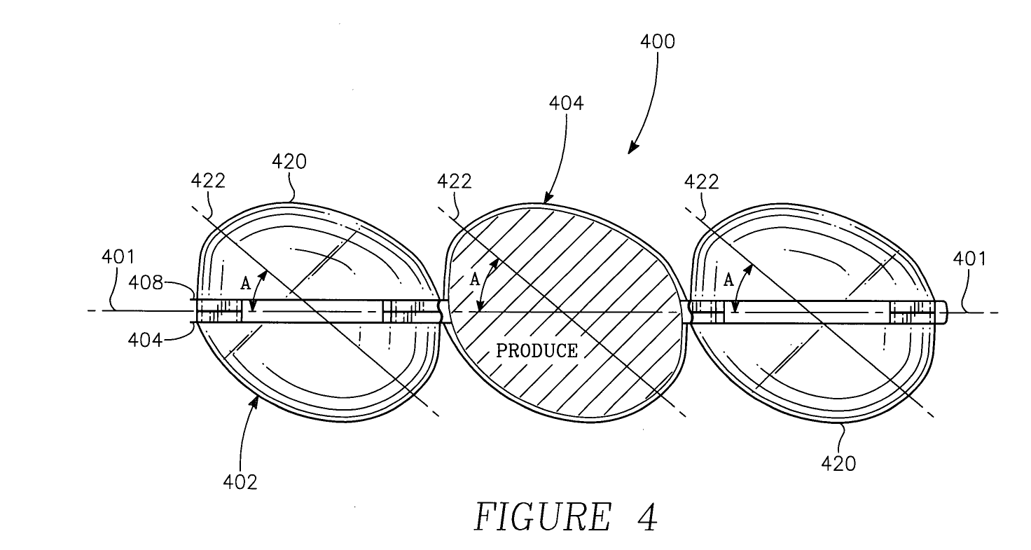

FIG. 4 shows one embodiment of the present invention where the package or container 400 has cells 420 which position the produce in an angled manner or reclined attitude. The cell 420 is shaped to generally conform to the produce and angle it relative to a centerline 401 of the package 400. The package centerline 401 is located between a lower tray 402 and an upper tray 406 such that with the package in its closed position (as shown), the centerline 401 is substantially parallel with both a lower interconnecting panel 404 and an upper interconnecting panel 408. The cell 420 also includes a substantially longitudinal axis 422 that bisects the cell 420 and is angled to the centerline 401 at an angle A.

Different embodiments of the invention have different values of angle A to match the desired reclining angle of the produce item. In some embodiments, the angle A is set between 0 degrees and 90 degrees. In certain embodiments the angle A is set between 35 degrees and 40 degrees. In at least one embodiment, the angle A is set at, or substantially at 37 degrees.

Besides that shown in FIG. 4, a variety of other cells positioned at angels relative to the package centerline as well as relative to other portions of the package are possible. For example, in other embodiments the cell can be offset about a vertical axis, relative to the package, by a desired angle to present the produce item in a canted or about an axis substantially parallel to, or coplanar with, the interconnecting panel to provide a slanted presentation. The angling of the cell also allows the total size of the package to be reduced by decreasing the effective size (e.g. length) of each cell.

As shown in FIGS. 1a and b, the package 100 also includes the edge spacers 140, the hinge spacers 160 and the center spacers 180. These spacers function in a variety of ways including separating the lower interconnecting panel 104 and the upper interconnecting panel 108 from each other to define the air space 116, providing structural support to the package, being capable of restraining the produce from moving within or out from the package, or both, and with some structures, providing a locking means to secure the lower tray 102 and the upper tray 106.

The edge spacers 140 are positioned about the outer edge of the package 100. The edge spacers 140 include lower edge spacer sections 142 positioned on the lower tray 102 and upper edge spacer sections 148 positioned on the upper tray 106. In the embodiment shown, the lower edge spacer sections 142 and the upper edge spacer sections 148 each extend about half the distance between the lower interconnecting panel 104 and the upper interconnecting panel 108. However, in other embodiments, the relative sizes, e.g., height, of the spacer sections 142 and 148 can vary. For example, the lower edge spacer section 142 could extend a majority of the distance between the panels 104 and 108 with the upper edge spacer section 148 extending the remaining distance. Also, each edge spacer 140 can include either just a lower edge spacer section 142 or an upper edge spacer section 148 extending between the lower and upper panels 104 and 108, respectfully. In such cases the particular spacer section will abut a portion of the interconnecting panel. The relative sizes of the lower and upper sections 142 and 148 can vary in each separate edge spacer 140, if desired.

The lower edge spacer sections 142 include lower edge spacer sides 144 and lower edge spacer contact surfaces 146. The upper edge spacer sections 148 include upper edge spacer sides 150 and upper edge spacer contact surfaces 152. In the event that a produce item is displaced from its cell 120 when the package 100 is closed, the edge spacer sides 144 and 150 are positioned to receive and retain the item. This can prevent the produce item from moving into another cell 120 or being displaced out of the package 100. With the package 100 closed, the lower and upper edge spacer contact surfaces 146 and 152 are positioned opposing each other, either in contact or adjacent one another. The contact surfaces 146 and 152 are not only capable of aiding in the spacing achieved by the edge spacers 140, but they also can provide a load transfer upon the application of a vertical load on the package 100.

The edge spacers 140 also include the edge locks 154 for securing the lower tray 102 with the upper tray 106. While the edge locks 154 can be any of a variety of types, in at least one embodiment the locks 154 include an interlocking edge lock tab 156 and edge lock recess 158. In at least one embodiment the edge locks are secured by an interference fit that is achieve by forming the edge lock tab 156 slightly larger than the and edge lock recess 158. Further, the thickness of the material of the recess 158 can be reduced to facilitate its deformation when receiving the lock tab 156.

The hinge spacer 160 is positioned adjacent the hinge 116. The hinge spacer 160 includes a lower hinge spacer section 162 positioned on the lower tray 102 and an upper hinge spacer section 168 positioned on the upper tray 106. In addition to the embodiment shown in FIGS. 1a and b, other sizes, e.g., heights, of the spacer sections 162 and 168 can be employed.

The lower hinge spacer section 162 includes lower hinge spacer sides 164 and a lower hinge spacer contact surface 166. The upper hinge spacer section 168 includes upper hinge spacer sides 170 and an upper hinge spacer contact surface 172. With the package 100 is closed, the hinge spacer sides 164 and 168 can retain a produce item from being displaced from adjacent cells 120. Also, when the package 100 is closed, the lower hinge spacer contact surfaces 166 and upper hinge spacer contact surfaces 172 are positioned opposing each other, either in contact or adjacent one another. The contact surfaces 166 and 172 are capable providing a load transfer upon the application of a vertical load on the package 100.

While the embodiment shown in FIGS. 1a and b has a single hinge spacer 160 positioned adjacent the hinge 116 and between the cells 120, other embodiments can employ more than one hinge spacer 116. For instance, with more than two cells 120 placed adjacent to the hinge 116, hinge spacers 160 can be placed between each cell 120. In still other embodiments, the hinge spacers can be excluded all together.

Unlike the edge spacers 140, in the embodiment shown, the hinge spacer 160 does not include a lock for securing the lower tray 102 with the upper tray 106. By not including a lock in the hinge spacer opening of the package 100 is facilitated as any binding resulting from the closeness of the hinge spacer 160 to the hinge 116 and the deformation of the package 100 is avoided. With the hinge 116 positioned near the hinge spacer 160, the position of lower tray 102 and the upper tray 106 can be maintained even without a lock at the hinge spacer 160.

In other embodiments, the hinge spacer 160 includes a lock structure. One such embodiment of the invention can be one which does not include the hinge 116 and therefore can use an additional means of securing the package 100 in its closed position.

The center spacers 180 are positioned within the center area of the package 100. As shown in the embodiment of FIGS. 1a and b, the package 100 includes two center spacers 180 each spaced between a set of four cells. In other embodiments of the invention less or more center spacers 180 are used. Also, the position of the center spacers 180 can be varied can be varied as necessary. In some embodiments the center spacers 180 are positioned to both provide vertical support to the structure of the package 100 and/or to limit any movement of one or more produce items from their respective cells 120.

While the shape of the center spacers 180 is shown with an angled square shape or a diamond shape, the center spacers 180 can be formed in any of a variety of other different shapes. The angled square shape results in side surfaces positioned adjacent each of the surrounding cells 120 such that they may received and restrict the movement of a produce item from any of these cells. Also, by allowing for an increased overall lateral size of the center spacers 180 for the given space between the cells 120, the angled square shape also improves the load bearing capabilities of the center spacers 180.

While the lateral size of the center spacers 180 can vary, and can extend to the edge of the cells 120, in embodiments such as that shown in FIGS. 1a and b, the center spacers 180 are sized to leave a space 181 between the center spacers 180 and the cells 120. With a produce item set in the cells 120, the space 181 creates a channel for the flow of air about the produce. This acts to promote uniform ripening of fruit and reduces problem such a development of mold.

The center spacers 180 include lower center spacer sections 182 positioned on the lower tray 102 and upper center spacer sections 188 positioned on the upper tray 106. In addition to the embodiment shown, varying sizes, e.g., heights, of the spacer sections 182 and 188 may be used to form the center spacers 180. In some cases either just the lower center spacer section 182 or just the upper center spacer section 188 form the center spacer 180. Also, different center spacers 180 may have different sized spacer sections 182 and 188.

The lower center spacer sections 182 include lower center spacer sides 184 and lower center spacer contact surfaces 186. The upper center spacer sections 188 include upper center spacer sides 190 and upper center spacer contact surfaces 192. With the package 100 is closed, the center spacer sides 184 and 190 can retain a produce item from being displaced from adjacent cells 120. Also, when package 100 is closed, the lower and upper center spacer contact surfaces 186 and 192 are positioned opposing each other, either in contact or adjacent one another. The contact surfaces 186 and 192 are capable providing a load transfer upon the application of a vertical load on the package 100.

In the embodiment shown, the center spacer 180 does not include a lock for securing the lower tray 102 with the upper tray 106. However, in other embodiments, the center spacers 180 include the locks for securing the lower tray 102 with the upper tray 106. These locks can be similar to the locks 154 with interlocking tabs and recesses.

While embodiments of the present invention have been described in detail above, many changes to these embodiments may be made without departing from the true scope and teachings of the present invention. The present invention, therefore, is limited only as claimed below and the equivalents thereof.

1. A produce container comprising:
a first cell for containing a first produce item;
a second cell for containing a second produce item, wherein the second cell is separate from the first cell; and
a separation structure positioned between the first cell and the second cell, wherein the separation structure is capable of preventing the first produce item from contacting the second produce item, wherein the separation structure connects the first cell and the second cell, wherein the separation structure comprises at least one stop positioned to be capable of restricting the movement of at least one of the first produce item and the second produce item, wherein the first cell is shaped to generally conform to the first produce item, and wherein the second cell is shaped to generally conform to the second produce item.

2. The produce container of claim 1, wherein the separation structure is an at least semi-rigid structure.

3. The produce container of claim 1, wherein the separation structure is a deformable structure.

4. The produce container of claim 1, wherein the first cell is canted such that the first produce item is positioned in a substantially reclined attitude.

5. The produce container of claim 1, wherein the first cell is sized larger than the first produce item such that a gap is defined between at least a portion of the first cell and the first produce item, such that air is capable of circulating about the first produce item.

6. The produce container of claim 1, wherein the first cell is substantially a teardrop shape.

7. A produce container comprising:
a base structure; and
a cell for containing a produce item positioned upon the base structure, wherein the cell is shaped to generally conform to the produce item, and wherein the cell is canted to the base structure, such that the produce item is positioned at an angled attitude.

8. The produce container of claim 7, wherein the cell includes a cell axis, wherein the base includes a base axis, and wherein the cell axis is set at a cant angle to the base axis.

9. The produce container of claim 8, wherein the cell axis is a longitudinal axis positioned to substantially bisect the cell.

10. The produce container of claim 8, wherein the cant angle is between 0 degrees and 90 degrees.

11. The produce container of claim 8, wherein the cant angle is between 35 degrees and 40 degrees.

12. The produce container of claim 8, wherein the cant angle is substantially 37 degrees.

13. The produce container of claim 8, wherein the cell is generally a teardrop shape.

14. A produce container having an opened position and a closed position, wherein the produce container comprises:
a first tray;
a second tray positioned opposite the first tray with the produce container in the closed position;
a plurality of cells for containing produce items, wherein each cell is positioned within the first tray and the second tray, and wherein each cell is separated from the each of the other cells, such that each produce item is prevented from contacting another produce item; and
at least one spacer positioned between the first tray and the second tray defining an air space between the first tray and the second tray.

15. The produce container of claim 14, wherein the produce container further comprises a hinge mounted between the first tray and the second tray, such that the produce container can be translated from its open position to its closed position by moving the one of the first tray and the second tray about the hinge.

16. The produce container of claim 14, wherein the first tray has a center area and the second tray has a center area, wherein the at least one spacer comprises a center spacer positioned at least substantially adjacent the center area of at least one of the first tray and the second tray.

17. The produce container of claim 15, wherein the first tray has a center area and the second tray has a center area, wherein the at least one spacer comprises a center spacer for further defining the air space between the first tray and the second tray and for being capable of providing structural support to the produce container, wherein the center spacer is positioned at least substantially adjacent the center area of at least one of the first tray and the second tray.

18. The produce container of claim 17, wherein the center spacer further comprises a lock for attaching the first tray and the second tray together.

19. The produce container of claim 14, wherein the at least one spacer comprises a center spacer and wherein the plurality of cells is four cells positioned about the center spacer.

20. The produce container of claim 14, wherein the at least one spacer comprises two center spacers and wherein the plurality of cells is six cells positioned such that four cells are positioned about each center spacer.

21. The produce container of claim 14, wherein each of the plurality of cells is canted at an angle.

22. The produce container of claim 21, wherein with the produce container in the closed position the first tray and the second tray are positioned about a central plane, wherein each cell includes a cell axis set at a cant angle to the central plane.

23. The produce container of claim 22, wherein the cell axis is a longitudinal axis positioned to substantially bisect the cell.

24. The produce container of claim 22, wherein the cant angle is between 35 degrees and 40 degrees.

25. The produce container of claim 22, wherein the cant angle is substantially 37 degrees.

26. The produce container of claim 14, wherein each cell of the plurality of cells is substantially a curved shape.

27. The produce container of claim 14, wherein each cell of the plurality of cells is substantially a teardrop shape.

28. The produce container of claim 14, wherein each cell of the plurality of cells is substantially in the shape of a mango.
